(19) United States
(12) Patent Application Publication
(10) Pub. No.: US 2024/0360352 A1
(43) Pub. Date: Oct. 31, 2024

(54) HEAT TRANSFER FLUIDS BASED ON SYNTHETIC ESTERS

(71) Applicant: VGP IPCO LLC, Lexington, KY (US)

(72) Inventors: Sulaksha Parab, Goa (IN); Keshav Sopan Badhe, Mumbai (IN); Rajkumar Rajule, Kalyan West (IN); Gefei Wu, Lexington, KY (US); Ning Ren, Naperville, IL (US); Roger England, Lexington, KY (US); Ying Yang, Lexington, KY (US)

(21) Appl. No.: 18/647,739

(22) Filed: Apr. 26, 2024

Related U.S. Application Data
(60) Provisional application No. 63/498,882, filed on Apr. 28, 2023.

(51) Int. Cl. C09K 5/20; C07C 69/24; C07C 69/28; C07C 69/42; C07C 69/44; C07C 69/704; C10M 105/34; C10M 105/36; C10M 105/40; C10N 30/02; C10N 40/25; F01P 3/00

(52) U.S. Cl. CPC C09K 5/20; C07C 69/24; C07C 69/28; C07C 69/42; C07C 69/44; C07C 69/704; C10M 105/34; C10M 105/36; C10M 105/40; F01P 3/00; C10M 2207/2815; C10M 2207/2825; C10N 2030/02; C10N 2040/25; F01P 2003/001

(57) ABSTRACT

Heat transfer fluids were formulated with a neat solution of a synthetic ester base stock. A base stock prepared with a neat ester according to the invention has similar performance characteristics to commercially available heat transfer fluids.

### REFERENCE TO RELATED APPLICATIONS

This application claims priority from U.S. Provisional Patent Application No. 63/633,332, filed on Apr. 28, 2023, which is incorporated by reference herein in its entirety.

### TECHNICAL FIELD

This disclosure relates to heat transfer fluids primarily composed of an ester base stock. Also, this disclosure relates to a method for conducting heat transfer in a heating and/or cooling system using a heat transfer fluid having an ester base stock.

### BACKGROUND

Transfer of heat from local high temperature zones is a critical performance feature of lubricants and circulating fluids. Specialized fluids are used for the sole purpose of removing heat from high temperature zones, e.g. coolants in internal combustion engines. Currently, there is a need to cool the battery and power generation systems in electric or hybrid vehicles using fluids aimed for heat removal. Traditional fluids remove heat via combination of conductivity and convection mechanisms and the heat removed is a function of fluid properties such as heat capacity, thermal conductivity, density and viscosity. Improving heat transfer is an emerging need as energy density of systems and equipment increases.

The use of dielectric fluids in electrical apparatus is well known which provides electrical insulation, cooling and prevent excessive temperature rise, and thus prolong the lifetime of equipment. Dielectric fluids known for such use include paraffinic base fluids, mineral oil based fluids, natural ester based fluids and synthetic ester based fluids. Known synthetic esters include those produced from the reaction of an alcohol with one or more carboxylic acids. Dielectric fluids based on such synthetic esters have a number of advantages over paraffinic base fluids or mineral oil based fluids, but there remains a need for synthetic esters having improved properties.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some aspects, a heat transfer fluid comprising a neat ester stock or ester stock blend as a base fluid and an additive is described in detail.

Other methods, features and/or advantages is, or will become, apparent upon examination of the following figures and detailed description. It is intended that all such additional methods, features, and advantages be included within this description and are protected by the accompanying claims.

### BRIEF DESCRIPTION OF DRAWINGS

FIG. 1 is a table of synthetic esters of the invention.

FIG. 2 is a table of comparison of the synthetic esters of the invention with commercial fluids.

FIG. 3 is a table of elastomer-seal test date for synthetic esters of the invention and commercial fluids.

### DETAILED DESCRIPTION

### I. Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of +10% from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Weight percent: All weight (and mass) percents expressed herein (unless otherwise indicated) are based on overall composition weight.

### II. Ester Base Stock

According to some aspects of the invention, heat transfer fluids were formulated with a neat solution of a synthetic ester base stock. A base stock prepared with a neat ester according to the invention has similar performance characteristics to commercially available heat transfer fluids.

### III. Additives

In some aspects, the neat ester fluid will be formulated with an additive that may include antioxidant, agents, extreme pressure agents, dispersants, detergents, antioxidants, anti-wear agents, viscosity modifiers, pour point depressants, friction modifiers, corrosion inhibitors, anti-foaming agents, demulsifiers, or seal swell agents are used in amounts generally encountered in the art, for example between about 0.01 wt % and about 20 wt %, or between 1 wt % and about 20 wt %. In some formulations, the amount of total additive does not exceed 20 wt %. In some formulations, the amount of total additive does not exceed 10 wt %. In some formulations, the amount of total additive is between about 5 wt % and about 10 wt %. In some formulations, the amount of total additive if between 5 wt % and 10 wt %. In The lubricant may also contain a wt % of additive of any single number 6.4 wt %.

In some aspects, the additive may comprise an ester. However, the term “neat” ester in this context refers to the base stock that is a formulation comprising between about 80 wt % to 99.9 wt % of a neat ester solution.

Viscosity modifiers are also called as viscosity index improver or viscosity improvers. This may be included in the formulation. Viscosity index improver include reaction product of amines for example polyamines, with a hydrocarbyl substituent mono or dicarboxylic acid in which hydrocarbyl substituent comprises a chain of sufficient length to impart viscosity index improving properties to the compounds. In general, the viscosity improver may be polymer of a C4 to C24 unsaturated ester of unsaturated alcohol or C3 to C10 unsaturated monocarboxylic acid or a C4 to C10 dicarboxylic acid with an unsaturated nitrogen containing monomer having 4 to 20 carbon atoms, a polymer of C2 to C20 olefin with an unsaturated C3 to C10 mono or dicarboxylic acid neutralized with an amine, hydroxyl amine or an alcohol; or a polymer of ethylene with a C3 to C20 olefin further reacted either by grafting a C4 to C20 unsaturated nitrogen containing monomer or by grafting with an unsaturated acid on to the polymer backbone and then reacting carboxylic group of the grafted acid with amine, hydroxylamine or alcohol. Formulation may also include multifunctional viscosity modifier which may have both dispersant and antioxidant properties.

The compositions may contain a viscosity modifier or a combination of viscosity modifiers. The viscosity improvers used in the lubricant industry can be used in the instant invention for the oil medium, which include olefin copolymers (OCP), polymethacrylates (PMA), hydrogenated styrene-diene (STD), and styrene-polyester (STPE) polymers. Olefin copolymers are rubber-like materials prepared from ethylene and propylene mixtures through vanadium-based Ziegler-Natta catalysis. Styrene-diene polymers are produced by anionic polymerization of styrene and butadiene or isoprene. Polymethacrylates are produced by free radical polymerization of alkyl methacrylates. Styrene-polyester polymers are prepared by first co-polymerizing styrene and maleic anhydride and then esterifying the intermediate using a mixture of alcohols.

Other compounds which can be used in the instant invention in the oil medium include: acrylic polymers such as polyacrylic acid and sodium polyacrylate, high-molecular-weight polymers of ethylene oxide such as Polyox WSR from Union Carbide, cellulose compounds such as carboxymethylcellulose, polyvinyl alcohol (PVA), polyvinyl pyrrolidone (PVP), xanthan gums and guar gums, polysaccharides, alkanolamides, amine salts of polyamide, hydrophobically modified ethylene oxide urethane, silicates, and fillers such as mica, silicas, cellulose, wood flour, clays (including organoclays) and clays, and resin polymers such as polyvinyl butyral resins, polyurethane resins, acrylic resins and epoxy resins.

A viscosity modifier may be present in the final formulation in an amount from about 0.1 wt % to about 10 wt % on a pure rubber basis. In some aspects a viscosity modifier is selected so as to provide the final formulation rubber in an amount between about 0.1 wt % and 2 wt %. The amount of rubber in the final formulation may be between about 0.1 wt % and about 1 wt % or any number within that range, e.g. 0.7 wt %.

Pour point depressant are used to allow the lubricant formulation to operate at lower temperature. Typical additives which improves the fluidity of lubricant formulation are C8 to C18 dialkyl fumarate/vinyl acetate copolymer and polymethacrylates.

In addition, any defoamer or antifoamer that may be present in the additive package, at least one additional antifoamer may be added to the composition. At least two antifoamers are added to the heat transfer fluid. More than two antifoamers may also be added to the heat transfer fluid. The heat transfer fluid may include an anti-foaming agent that is an organic acid ester, a siloxane, a silicone based fluid or a combination of any of these compounds. One antifoamer, may include a mixture of compounds such as an organic acid ester and siloxane, such as, for example, the commercially available Nalco®2301. One antifoamer may be silicone based, such as for example the commercially available Chemaloy F-655.

The final composition may include the anti-foaming agent in an amount greater than about 0.01 (w/w) % and less than about 0.5 (w/w) %. The anti-foaming agent maybe present in an amount of about 0.1 (w/w) %. The anti-foaming agent may be described by any single digit found in the range between about 0.01 (w/w) % and less than about 0.5 (w/w) %, such as 0.1 wt %. The anti-foaming agent may be a mixture of organic acid ester and siloxane or a silicone based fluid. The heat transfer fluid may contain one, two or more than two anti-foaming agents. The antifoaming agent may comprise any appropriate defoamer.

The heat transfer fluids may also include additives in the form of an additive package. The performance additive package is generally a fully formulated composition, including antioxidant agents, antiwear agents, extreme pressure agents, detergents, dispersants, antifoamer, anti-rust agents, friction modifiers, corrosion inhibitors, and pour point depressants. The performance additive package may be commercially available, such as DI package, and used as directed by manufacturer. Additives such as a colorant or dye may also be added to the heat transfer fluid.

Dispersants commonly used in the automotive industry contain a lipophilic hydrocarbon group and a polar functional hydrophilic group. The polar functional group can be of the class of carboxylate, ester, amine, amide, imine, imide, hydroxyl, ether, epoxide, phosphorus, ester carboxyl, anhydride, or nitrile. The lipophilic group can be oligomeric or polymeric in nature, usually from 70 to 200 carbon atoms to ensure good oil solubility. Hydrocarbon polymers treated with various reagents to introduce polar functions include products prepared by treating polyolefins such as polyisobutene first with maleic anhydride, or phosphorus sulfide or chloride, or by thermal treatment, and then with reagents such as polyamine, amine, ethylene oxide, etc. A surfactant or a mixture of surfactants with low HLB value (typically less than or equal to 8), preferably nonionic, or a mixture of nonionics and ionics, may be used as a dispersant.

Other chemical compounds, preferably polymers, not for the purpose of dispersing, but to achieve thickening or other desired fluid characteristics. These can be added but reduce the amount of particulate that can be used without excessive thickening.

Chemical compounds such as seal swell agents or plasticizers can also be used in the instant invention and may be selected from the group including phthalate, adipate, sebacate esters, and more particularly: glyceryl tri (acetoxystearate), epoxidized soybean oil, epoxidized linseed oil, n-butyl benzene sulfonamide, aliphatic polyurethane, epoxidized soy oil, polyester glutarate, polyester glutarate, triethylene glycol caprate/caprylate, long chain alkyl ether, dialkyl diester glutarate, monomeric, polymer, and epoxy plasticizers, polyester based on adipic acid, hydrogenated dimer acid, distilled dimer acid, polymerized fatty acid trimer, ethyl ester of hydrolyzed collagen, isostearic acid and sorbian oleate and cocoyl hydrolyzed keratin, PPG-12/PEG-65 lanolin oil, dialkyl adipate, alkylaryl phosphate, alkyl diaryl phosphate, modified triaryl phosphate, triaryl phosphate, butyl benzyl phthalate, octyl benzyl phthalate, alkyl benzyl phthalate, dibutoxy ethoxy ethyl adipate, 2-ethylhexyldiphenyl phosphate, dibutoxy ethoxy ethyl formyl, diisopropyl adipate, diisopropyl sebacate, isodecyl oieate, neopentyl glycol dicaprate, neopenty giycol diotanoate, isohexyl neopentanoate, ethoxylated lanolins, polyoxyethylene cholesterol, propoxylated (2 moles) lanolin alcohols, propoxylated lanoline alcohols, acetylated polyoxyethylene derivatives of lanoline, and dimethylpolysiloxane. Other plasticizers which may be substituted for and/or used with the above plasticizers including glycerine, polyethylene glycol, dibutyl phthalate, and 2,2,4-trimethyl-1,3-pentanediol monoisobutyrate, and diisononyl phthalate all of which are soluble in a solvent carrier. Other seal swelling agents such as LUBRIZOL 730 can also be used.

The additives may be added individually or as an additive package.

In some aspects the additive package may be in the form of a concentrate that is diluted to supply the final formulation.

In some aspects, compositions of the invention comprises a heat transfer fluid comprising a neat ester stock or ester stock blend as a base fluid and an additive. In some aspects, heat transfer fluid is consisting essentially of a neat ester stock or ester stock blend as a base fluid and an additive heat transfer fluid or a heat transfer fluid consisting of a neat ester stock or ester stock blend as a base fluid and an additive.

In some aspects, the neat ester stock or ester stock blend is present in an amount between 80 wt % and 99.9 wt % and the additive is present in an amount between 0.1 wt % and 20 wt %.

In some aspects, the additive of the heat transfer fluid is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

In some aspects, compositions of the invention are characterized by a density @ 25° C. (g/cc) of between about 0.9100 and about 0.9600, or alternatively by a density @ 25° C. (g/cc) of between about 0.9200 and about 0.9500, or alternatively by a density @ 25° C. (g/cc) of between 0.9200 and 0.9500, or alternatively by a density @ 25° C. (g/cc) of any number within the range of 0.9200 and 0.9500.

In some aspects, compositions of the invention are characterized by a Brookfield viscosity @-30° C. of between about 80 and about 500, or alternatively by a Brookfield viscosity @-30° C. of between about 100 and about 350, or alternatively by a Brookfield viscosity @−30° C. of between 100 and 350, or alternatively by a Brookfield viscosity @−30° C. or of any number within the range of 100 and 350.

In some aspects, compositions of the invention characterized by a kinematic viscosity @ 40° C. of between about 3.0 and about 9.0 or a kinematic viscosity @ 100° C. of between about 1.0 and about 3.0, or alternatively by a kinematic viscosity @ 40° C. of between about 4.0 and about 8.0 or a kinematic viscosity @ 100° C. of between about 1.5 and about 2.5, or alternatively by a kinematic viscosity @ 40° C. of between 4.0 and 8.0 or a kinematic viscosity @ 100° C. of between 1.5 and 2.5, or alternatively by a kinematic viscosity @ 40° C. of any number within the range of 4.0 and 8.0 or a kinematic viscosity @ 100° C. of any number within the range of 1.5 and 2.5.

In some aspects, compositions of the invention are characterized by a viscosity index of between about 60 and about 130, or alternatively by a viscosity index of between about 70 and about 120, or alternatively by a viscosity index of between 70 and 120, or alternatively by a viscosity index of any number within the range of 70 and 120.

In some aspects, compositions of the invention are characterized by a thermal conductivity (w/mK) of between about 0.120 and about 0.150, or alternatively by a thermal conductivity (w/mK) of between about 0.125 and about 0.140, or alternatively by a thermal conductivity (w/mK) of between 0.125 and 0.140, or alternatively by a thermal conductivity (w/mK) of any number within the range of 0.125 and 0.140.

In some aspects, compositions of the invention are characterized by a heat capacity, Cp @ 28° C. (J/g° C.) of between about 1.750 and about 2.000, or alternatively by a heat capacity, Cp @ 28° C. (J/g° C.) of between about 1.800 and about 1.950, or alternatively by a heat capacity, Cp @ 28° C. (J/g° C.) of between 1.800 and 1.950, or alternatively by a heat capacity, Cp @ 28° C. (J/g° C.) of any number within the range of 1.800 and 1.950.

In some aspects, compositions of the invention are characterized by an electrical conductivity (ps/m) of between about 1,800 and about 160,000, or alternatively by an electrical conductivity (ps/m) of between about 1,860 and about 150,000, or alternatively by an electrical conductivity (ps/m) of between 1,860 and 150,000, or alternatively by an electrical conductivity (ps/m) of any number within the range of 1,860 and 150,000.

In some aspects, compositions of the invention are characterized by a neat ester stock blend of Ex 7, Ex 12 or Ex 14, or a blend of Ex 4, Ex 7, Ex 12 or Ex 14, a blend of Ex 4, Ex 7, Ex 12 or Ex 14 as a first ester together with a second ester, or any combination of Ex 1 through 28 as a first ester together with a second ester that is Ex 26, Ex 27, Ex 28.

### EXAMPLES

For the purposes of promoting an understanding of the principles of the present disclosure, reference will now be made to preferred aspects and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

### Example 1: Performance Characteristics of Neat Ester Base Stocks

The monoesters and diesters were synthesized by esterification of the corresponding monoacid (lauric acid), diacids (adipic acid and glutaric acid) with the corresponding alcohols. Twenty-eight specific structures (examples or Ex), defined by numerals 1-28 below are grouped into six basic structures, defined by Formula I-VI:

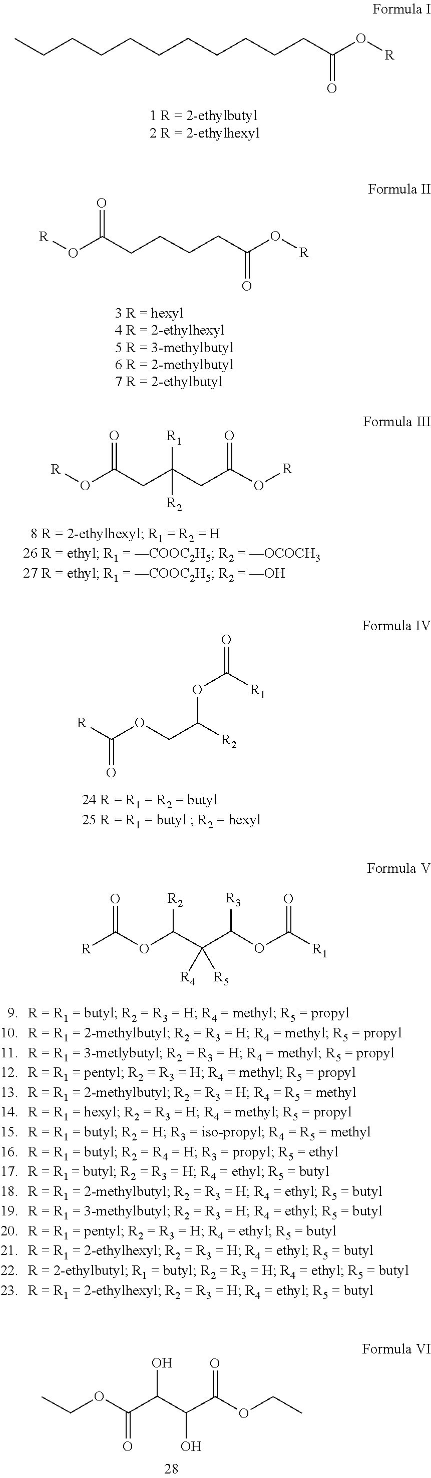

### Experimental

Ex 1 and Ex 2: Lauric acid (10.5 mmoles) and the corresponding alcohol (10 mmoles) in Toluene (50 mL) were heated to 140° C. with p-toluene sulfonic acid (PTSA) as a catalyst (1 mmole) for 8-12 h, as indicated by TLC, with azeotropic removal of water.

Ex 3 to Ex 7: Adipic acid (10.5 mmoles) and the corresponding alcohol (20 mmoles) in Toluene (50 mL) were heated to 140° C. with p-toluene sulfonic acid (PTSA) as a catalyst (1 mmole) for 8-12 h, as indicated by TLC, with azeotropic removal of water.

Ex 8: Glutaric acid (10.5 mmoles) and the corresponding alcohol (20 mmoles) in Toluene (50 mL) were heated to 140° C. with p-toluene sulfonic acid (PTSA) as a catalyst (1 mmole) for 8-12 h, as indicated by TLC, with azeotropic removal of water.

Ex 9 to Ex 25: The corresponding acid (21 mmoles) and the diol (10 mmoles) in Toluene (50 mL) were heated to 140° C. with p-toluene sulfonic acid (PTSA) as a catalyst (1 mmole) for 8 to 12 h, as indicated by TLC, with azeotropic removal of water.

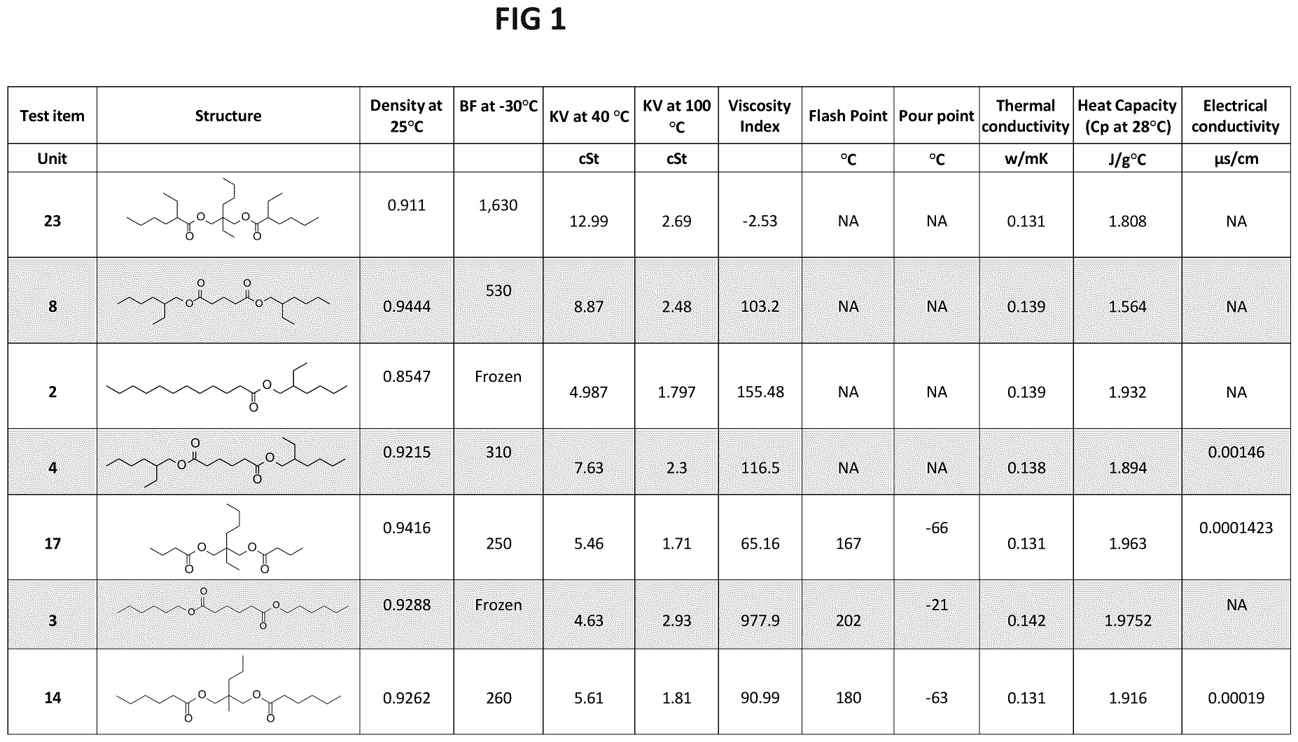

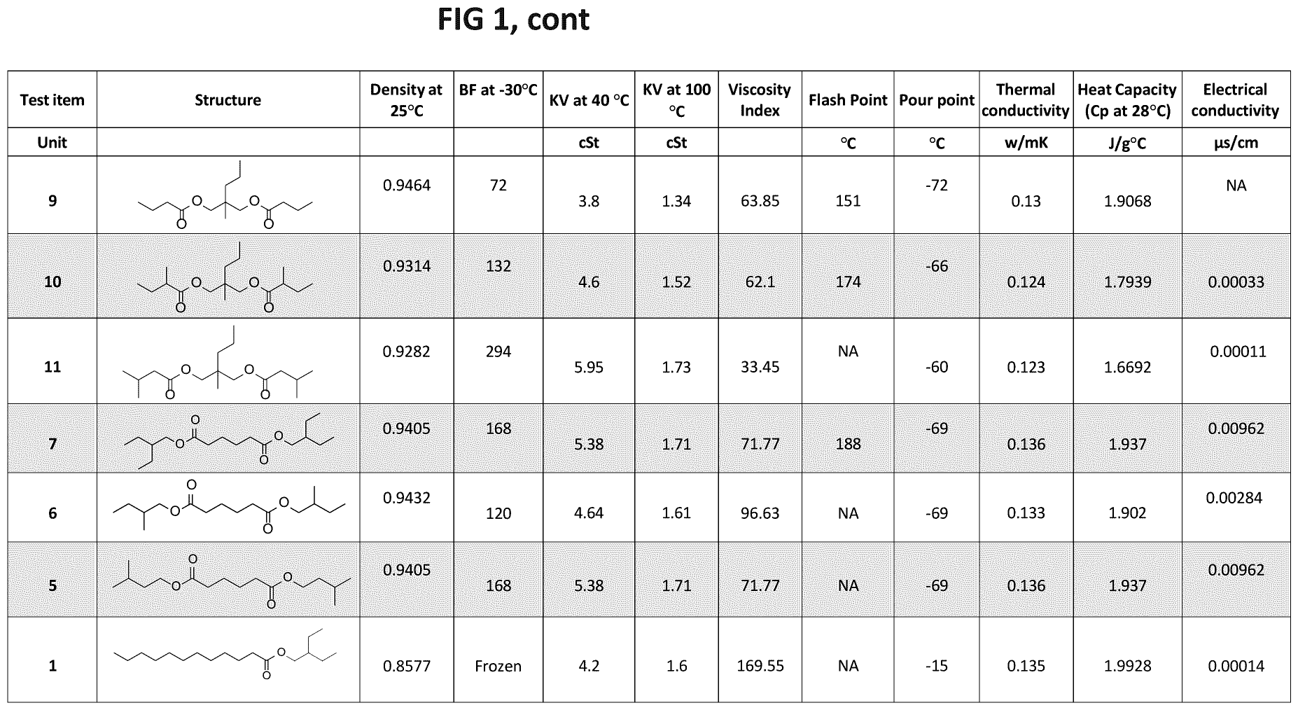

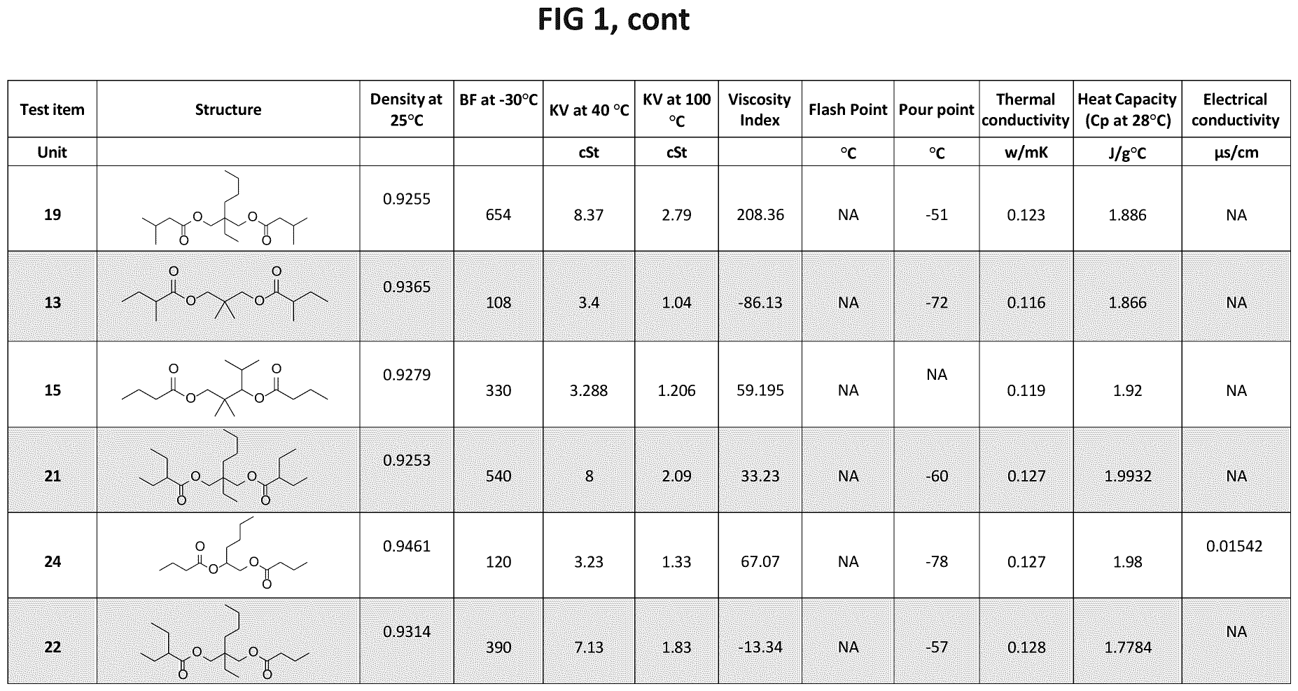

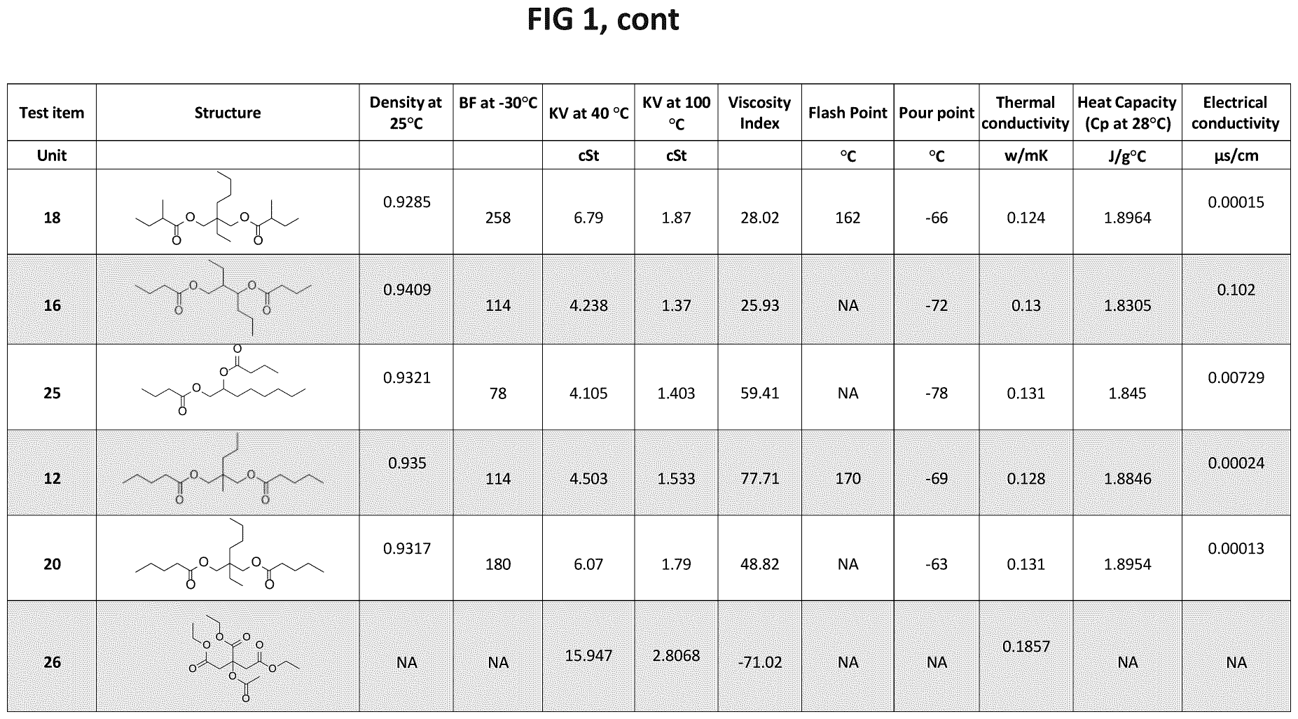

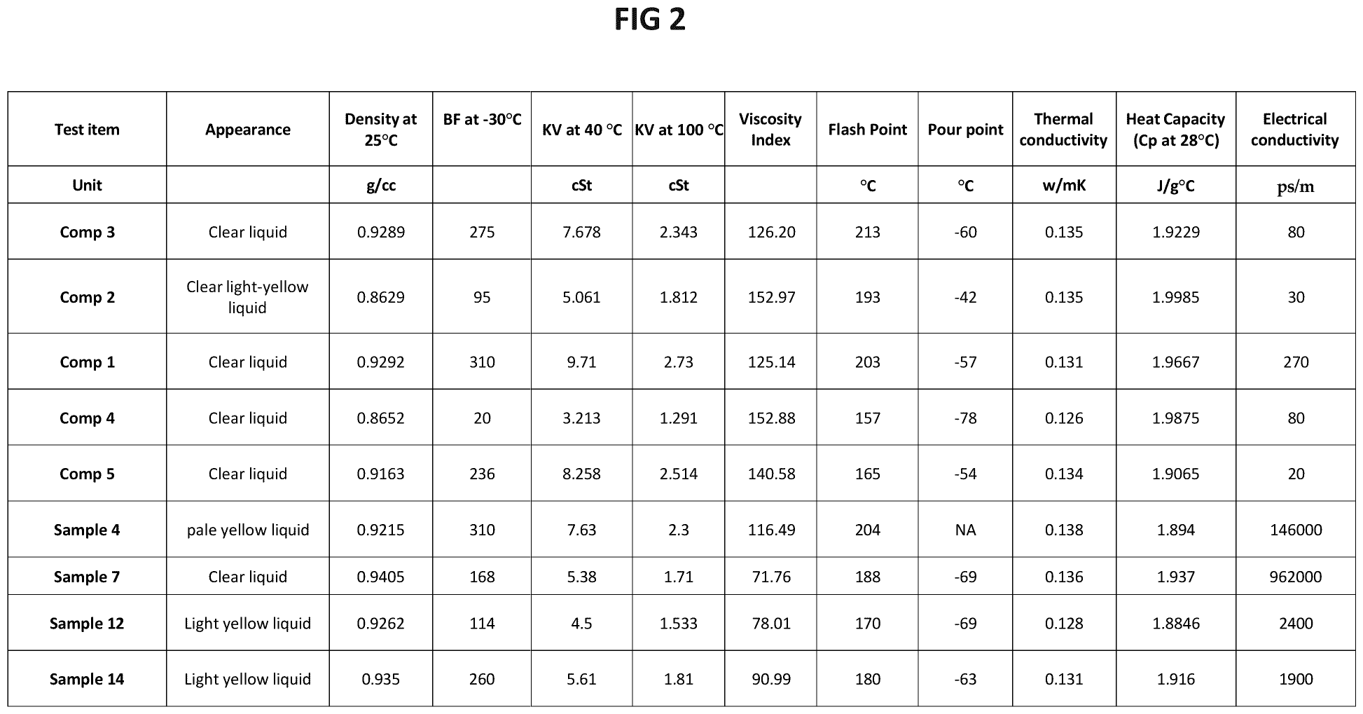

The detailed characteristics of a formulation comprising a neat base stock of structures 1 through 26 are detailed in FIG. 1. The esters (Ex 4, Ex 7, Ex 12 and Ex 14) had a comparable performance when compared with the reference commercial esters (Comp 1, Comp 2, Comp 3, Comp 4 and Comp 5) as shown in FIG. 2.

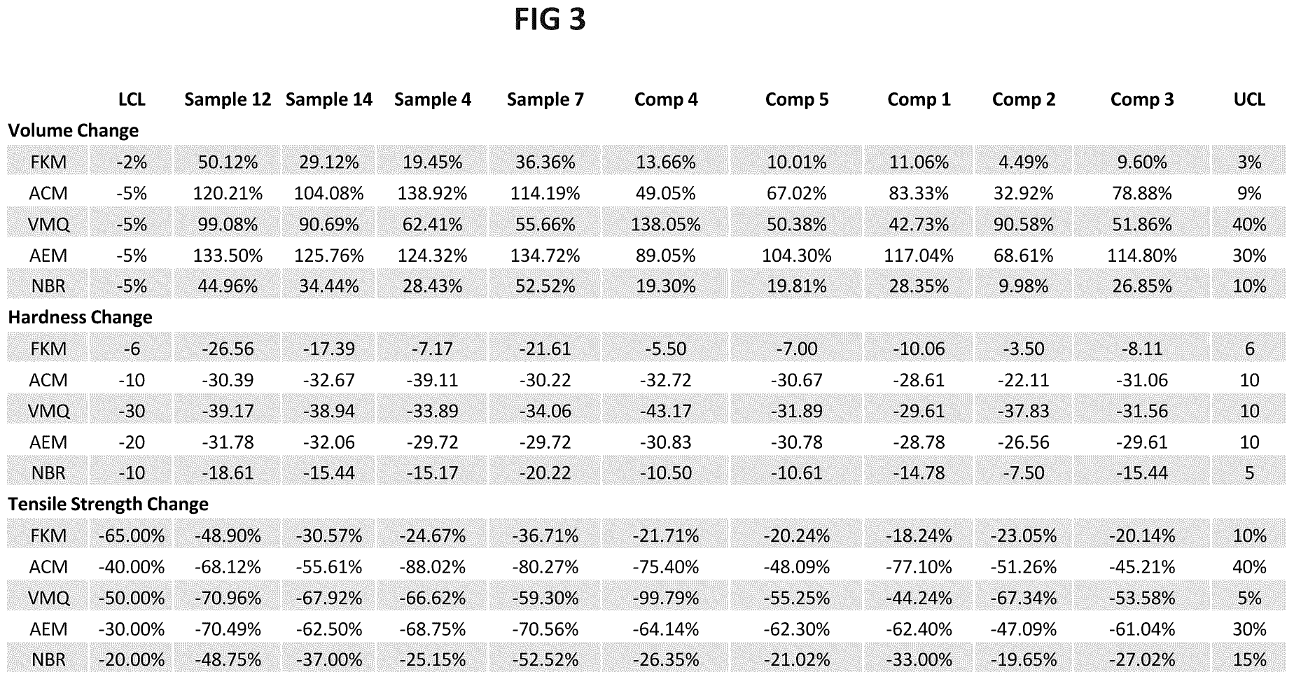

Elastomer seal tests were conducted on the neat ester base stocks (Ex 4, Ex 7, Ex 12 and Ex 14) and comparative esters. Results are shown in FIG. 3.

Thus, in one aspect, the heat transfer fluids comprise as a base stock that is a neat ester solution of the ester of Ex 4, Ex 7, Ex 12 or Ex 14.

In one aspect the base stock is comprises of an ester solution that is a blend of the ester of Ex 4, Ex 7, Ex 12 or Ex 14. In one aspect, a first ester may include the ester of Ex 4, Ex 7, Ex 12 or Ex 14 and a second ester may be any ester and the base stock may be a combination of the ester of Ex 4, Ex 7, Ex 12 or Ex 14 and a second ester.

### Example 2: Glutaric Acid or Diethyl Tartarate Based Ester Blends

New esters, based on substituted glutaric acid (Ex 26 and Ex 27) and diethyl tartarate (Ex 28), were also screened to study the improvement on the thermal conductivity of the synthesized esters through formulations. The formulations were prepared based on the thermal conductivities of the individual esters. The synthesized esters (Ex 7, 10, 11, 12, 14, 20, 24) were mixed with Ex 26 (the highest thermal conductivity) in 1:1 ratio and the properties (Kv 40° C., Kv 100° C. and thermal conductivity) were screened. Results are shown in Table 1.

TABLE 1
Formulation and performance characteristics
of esters and ester blends

| | | KV at 40° C. | KV at 100° C. | |
|---|---|---|---|---|
| Ex # | Content | cSt | cSt | Tc W/mK |
| 26 | Neat | 15.947 | 2.8068 | 0.1857 |
| 27 | Neat | — | — | 0.1343 |
| 28 | Neat | — | — | 0.1564 |
| 29 | Ex 20 + Ex 26 | 7.2081 | 1.9332 | 0.124 |
| 30 | Ex 7 + Ex 26 | 7.3030 | 2.0521 | 0.1177 |
| 31 | Ex 14 + Ex 26 | 7.7525 | 2.0466 | 0.1121 |
| 32 | Ex 10 + Ex 26 | 7.3883 | 1.9235 | 0.1253 |
| 33 | Ex 12 + Ex 26 | 6.9799 | 1.9151 | 0.1275 |
| 34 | Ex 11 + Ex 26 | 8.4488 | 2.0539 | 0.1238 |
| 35 | Ex 24 + Ex 26 | 7.0677 | 1.7161 | 0.1424 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A heat transfer fluid comprising a neat ester stock or ester stock blend as a base fluid and an additive.

2. The heat transfer fluid of claim 1, wherein the neat ester stock or ester stock blend is present in an amount between 80 wt % and 99.9 wt % and the additive is present in an amount between 0.1 wt % and 20 wt %.

3. The heat transfer fluid of claim 1, wherein the additive is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

4. The heat transfer fluid of claim 1, wherein the fluid has a density @ 25° C. (g/cc) of between about 0.9100 and about 0.9600.

5. The heat transfer fluid of claim 1, wherein the fluid has a Brookfield viscosity @−30° C. of between about 80 and about 500.

6. The heat transfer fluid of claim 1, wherein the fluid has a kinematic viscosity @ 40° C. of between about 3.0 and about 9.0 or a kinematic viscosity @ 100° C. of between about 1.0 and about 3.0.

7. The heat transfer fluid of claim 1, wherein the fluid has a viscosity index of between about 60 and about 130.

8. The heat transfer fluid of claim 1, wherein the fluid has a thermal conductivity (w/mK) of between about 0.120 and about 0.150.

9. The heat transfer fluid of claim 1, wherein the fluid has a heat capacity, Cp @ 28° C. (J/g° C.) of between about 1.750 and about 2.000.

10. The heat transfer fluid of claim 1, wherein the fluid has an electrical conductivity (ps/m) of between about 1,800 and about 160,000.

11. The heat transfer fluid of claim 1, wherein the neat ester stock is Ex 4.

12. The heat transfer fluid of claim 1, wherein the neat ester stock is Ex 7, Ex 12 or Ex 14.

13. A heat transfer fluid comprising an ester stock as a base fluid and an additive, wherein the ester stock is:
a blend of Ex 4, Ex 7, Ex 12 or Ex 14,
a blend of Ex 4, Ex 7, Ex 12 or Ex 14 as a first ester together with a second ester,
a blend of Ex 4, Ex 7, Ex 12, Ex 14, or any combination thereof as a first ester together with a second ester that is Ex 26, Ex 27, Ex 28, or any combination thereof,
wherein the heat transfer additive has an electrical conductivity (ps/m) of between about 1,850 and about 150,000, and a viscosity index of between about 70 and about 120.

14. The heat transfer fluid of claim 13, wherein the neat ester stock is present in an amount between 80 wt % and 99.9 wt % and the additive is present in an amount between 0.1 wt % and 20 wt %.

15. The heat transfer fluid of claim 13, wherein the additive is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

16. A method of cooling an engine comprising use of a heat transfer fluid within the motor, the fluid comprising:
a neat ester stock of Ex. 4 Ex 7, Ex 12 or Ex 14 in an amount between 80 wt % and 99.9 wt % and an additive in an amount between 0.1 wt % and 20 wt %,
wherein the heat transfer fluid efficiently cools the portion of the engine with which the fluid is in contact.

17. The method of claim 16, wherein the heat transfer fluid has:
a density @ 25° C. (g/cc) of between about 0.9100 and about 0.9600,
a Brookfield viscosity @−30° C. of between about 80 and about 500,
a kinematic viscosity @ 40° C. of between about 3.0 and about 9.0 or a kinematic viscosity @ 100° C. of between about 1.0 and about 3.0, or
a viscosity index of between about 60 and about 130.

18. The method of claim 16, wherein the heat transfer fluid has a thermal conductivity (w/mK) of between about 0.120 and about 0.150.

19. The method of claim 16, wherein the heat transfer fluid has a heat capacity, Cp @ 28° C. (J/g° C.) of between about 1.750 and about 2.00.

20. The method of claim 16, wherein the heat transfer fluid has an electrical conductivity (ps/m) of between about 1,800 and about 160,000.
